(19) United States
(12) Patent Application Publication
(10) Pub. No.: US 2009/0210468 A1
(43) Pub. Date: Aug. 20, 2009

(54) GENERATION OF THERMAL AGITATION NOISE ACCORDING TO A PREDETERMINED HISTOGRAM

(76) Inventor: Jean-Michel Hode, Saint-Cloud (FR)

Correspondence Address: LOWE HAUPTMAN & BERNER, LLP, 1700 DIAGONAL ROAD, SUITE 300, ALEXANDRIA, VA, 22314, US

(21) Appl. No.: 10/574,291

(22) PCT Filed: Sep. 30, 2004
(86) PCT No.: PCT/EP04/52368

§ 371 Date: Nov. 22, 2006

(30) Foreign Application Priority Data
Oct. 3, 2003 (FR) 0311621

(51) Int. Cl. G06F 7/58

(52) U.S. Cl. 708/250

(57) ABSTRACT

The invention relates to a method and a device for generating agitation noise, and the agitation noise obtained.

A subject of the invention is a method for generating agitation noise comprising an arbitrary number of points, with predetermined histogram, shaped around at least one frequency comprising:
the generation of noise by a succession of several sequences {h(kN+n)}_{1≦n≦N} of M.N points (M, N integers≧1),
[S2]: the choosing for each sequence of M basic subsequence(s) {hₗₘ(n)}_{1≦n≦N, m≦M} in a random and independent manner from among at least L basic subsequence(s) of N shaped points (L integer≧1),
[S4]: the choosing in a random and independent manner, for each sequence, of the sign.

Thus, by not simply repeating the subsequence, the spectrum of the agitation noise obtained has no spectral lines.

A second variant of the invention furthermore comprises [S6]: the choosing in a random and independent manner, for each sequence, of the direction of temporal reading of each of the chosen basic subsequences.

A third variant of the invention furthermore proposes, for each sequence, [S8]: the interleaving E of the M chosen subsequences.

The invention relates to a method for generating agitation noise, a device for generating agitation noise and associated agitation noise. The agitation noise thus generated comprises an arbitrary number of points, with predetermined histogram, and is shaped around at least one arbitrary frequency.

The generation of agitation noise (also called “dither”) with predetermined histogram shaped around one or more very precise frequencies (in a band where the useful signal is situated) is a significant element, in particular the generation of agitation noise with rigorously flat histogram so as to best linearize the characteristics of analog/digital and digital/analog converters. Thus, the use of dither makes it possible to time average the errors introduced by the converter.

So as not to leave traces during subsequent processings (integration over significant times) it is imperative that this “dither” be represented in the form of genuine noise (whose maximum level under the useful signal decreases with resolution, that is to say integration time) and is devoid of spectral lines whose level under the useful signal does not depend on the resolution.

A technique for obtaining such dither is the filtering of a white noise. However, filtering gives rise to a distortion of the histogram, thereby limiting the ability of the dither thus constituted to remove the low-ranking harmonics. Furthermore it is important that the signal thus obtained does not include long-range correlation (short-range correlation being intrinsically tied to shaping) since such a correlation brings a spectrum with spectral lines limiting the dynamic range of the receivers and decoders and introducing a spurious signal.

Another technique described by patent application FR No. 02 15066 consists in compensating at the histogram level for the distortion introduced by the filtering of the white noise and in iterating the process. This technique makes it possible to limit the distortion of the histogram without introducing long-range correlation. However, it does not make it possible to obtain shapings “termed” steep, that is to say close to the inverse gate function in spectral terms. And, this technique on account of the search for compensation and the iteration imposes high calculation costs.

The present invention makes it possible to alleviate these drawbacks by proposing to use, sequentially, basic noise subsequences of reduced size of given histogram and of spectrum shaped in a random and independent manner by randomly varying their signs. Thus, by not simply repeating the subsequence, the spectrum of the agitation noise obtained has a level which diminishes with the total size of the signal thus generated and has no spectral lines.

A subject of the invention is a method for generating agitation noise comprising an arbitrary number of points, with predetermined histogram, shaped around at least one frequency comprising:
the generation of noise by a succession of several sequences of M.N points (M, N integers≧1),
the choosing for each sequence of M subsequence(s) in a random and independent manner from among at least L basic subsequence(s) of N points shaped around a predetermined frequency (L integer≧1),
the choosing in a random and independent manner, for each sequence, of the sign applied to each of the chosen subsequences.

A second variant of the invention proposes the above agitation noise generation method comprising the choosing in a random and independent manner, for each sequence, of the direction of temporal reading of each of the chosen basic subsequences.

This second variant makes it possible to guarantee the absence of spectral lines in the case of an antisymmetric response and to avoid long-term correlation.

A third variant of the invention proposes one of the agitation noise generation methods above comprising, furthermore, for each sequence, the interleaving of the M chosen subsequences.

This third variant makes it possible to focus on the spectrum according to a ratio 1/M and to transpose it around a series of frequencies which depend on the number M of subsequences chosen and on the frequency of the basic subsequences used.

The subject of the invention is also a device for generating agitation noise comprising an arbitrary number of points, with predetermined histogram, shaped around at least one arbitrary frequency implementing the method above, the said device comprising:
means of successive provision (7) of several sequences {h(kN+n)}_{1≦n≦N} of M.N points (M, N integers≧1),
means of selection (1), for each sequence, of M subsequence(s) {hₗₘ(n)}_{1≦n≦N, m≦M} in a random and independent manner from among at least L basic subsequence(s) of N points shaped around a predetermined frequency (L integer≧1),
means of selection (4), in a random and independent manner, for each sequence, of the sign applied to each of the chosen subsequences {hₗₘ(n)}_{1≦n≦N, m≦M}.

Another subject of the invention is a digital analog converter comprising an agitation noise generation device herein above.

The invention relates also to a frequency synthesis system comprising an agitation noise generation device herein above.

A subject of the invention is, furthermore, a sigma delta modulator comprising an analog digital converter on the direct channel, an agitation noise generation device herein above, an adder adding the agitation noise generated by the agitation noise generation device to the input of the analog digital converter, and a digital analog converter on the return channel.

The characteristics and advantages of the invention will appear more clearly on reading the description, offered by way of example, and the figures referring thereto which represent:

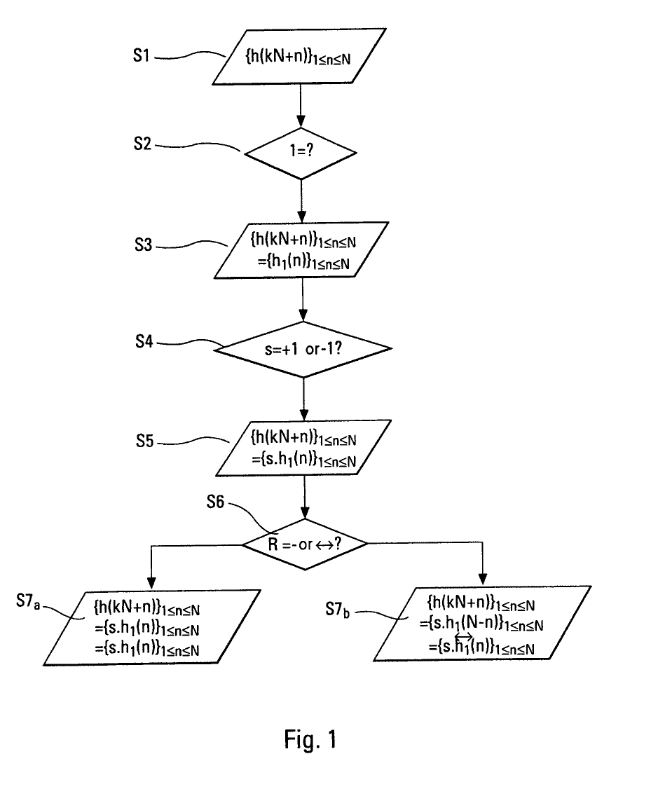

FIG. 1, a basic diagram of the generation of noise according to the second variant of the invention,

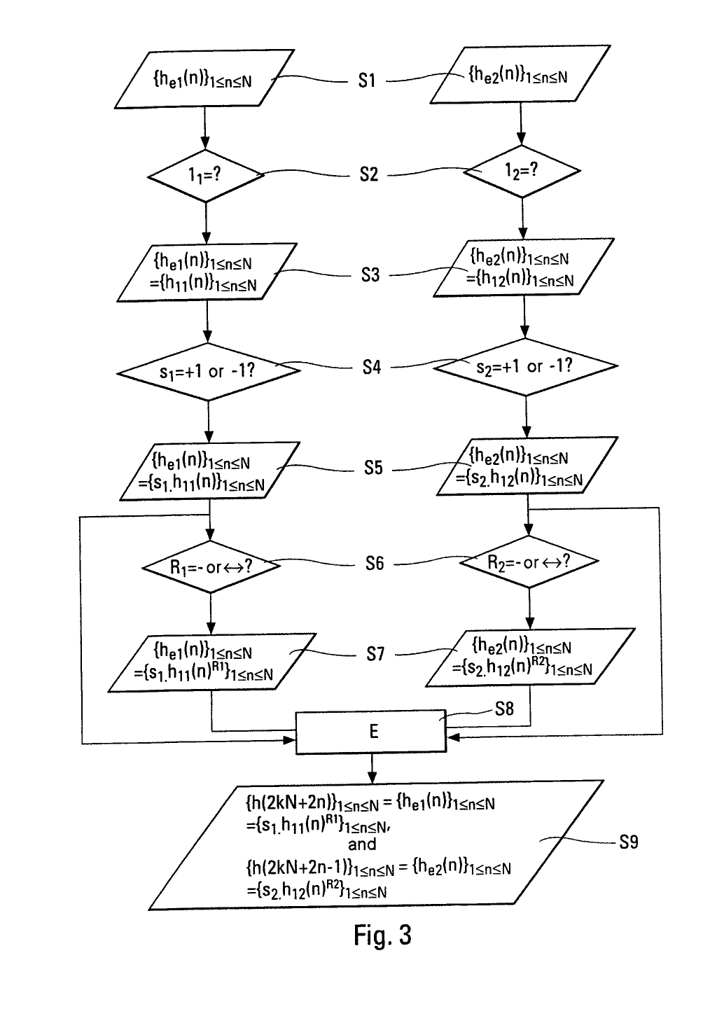

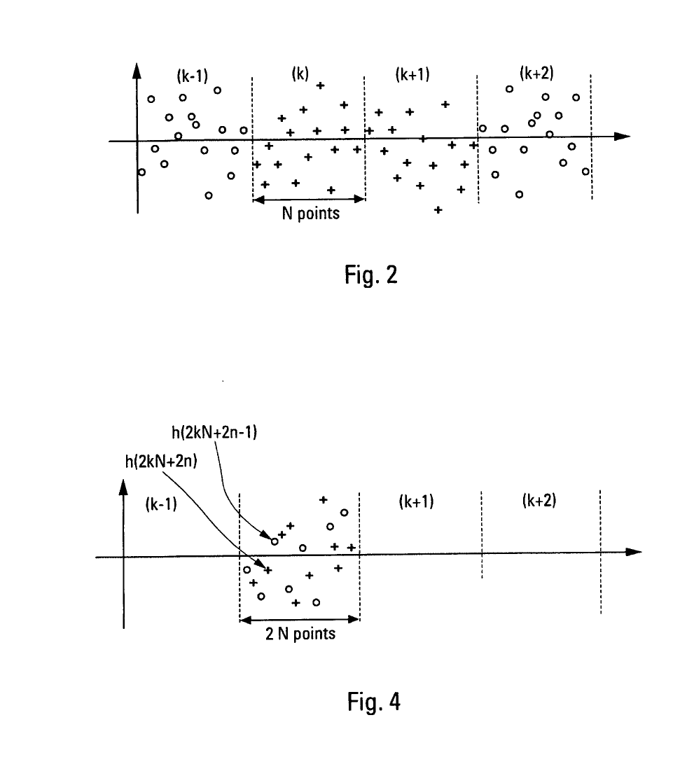

FIG. 2, a chart of the principle of the generation of noise according to the second variant of the invention,

FIG. 3, a basic diagram of the generation of noise according to the third variant of the invention,

FIG. 4, a chart of the principle of the generation of noise according to the third variant of the invention,

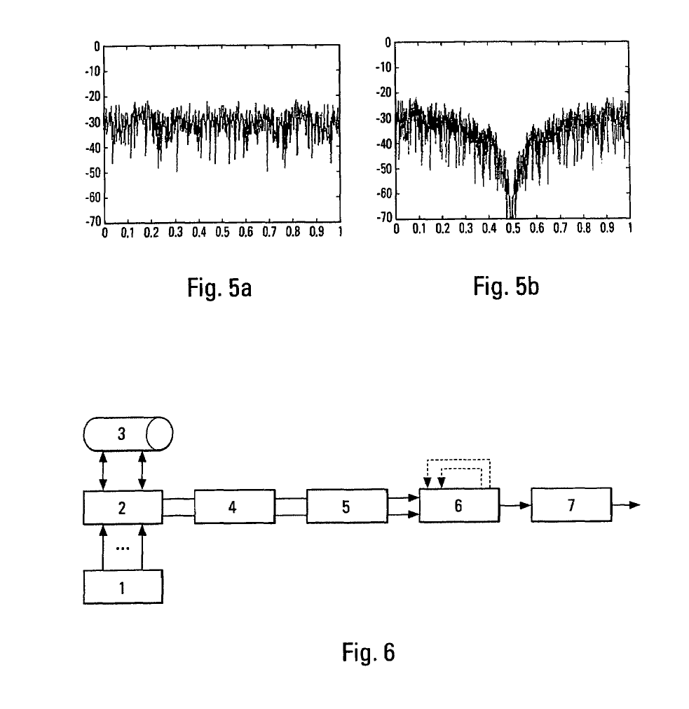

FIGS. 5a and b, spectral representations of the subsequences during an exemplary production of a basic subsequence, FIG. 5b represents the basic subsequence produced from the starting subsequence represented in FIG. 5a,

FIG. 6, a general block diagram of an exemplary embodiment of the agitation noise generation device according to the third variant of the invention,

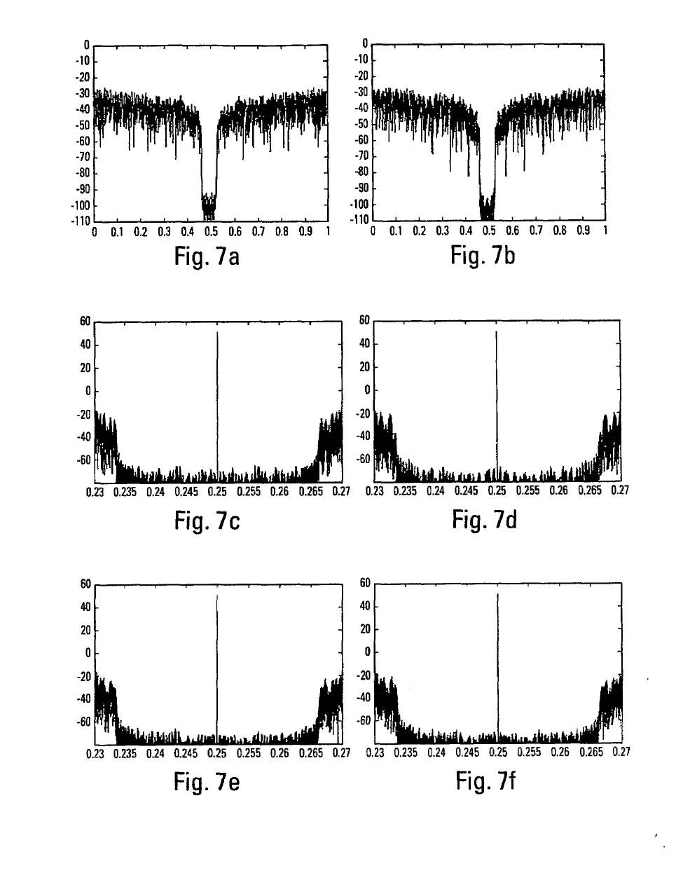

FIGS. 7a, 7b, 7c, 7d, 7e, and 7f, spectral representations of the subsequences and sequences during exemplary generations of dither according to the third variant of the invention around the frequency f_{ech}/4,
FIGS. 7a and 7b represent two distinct basic subsequences shaped around the frequency f_{ech}/2,
FIG. 7c represents the sequence obtained by interleaving the basic subsequence of FIG. 7a with itself,
FIG. 7d represents the sequence obtained by interleaving the basic subsequence of FIG. 7b with itself,
FIGS. 7e and 7f represent two sequences obtained by interleaving the basic subsequences of FIGS. 7a and 7b,

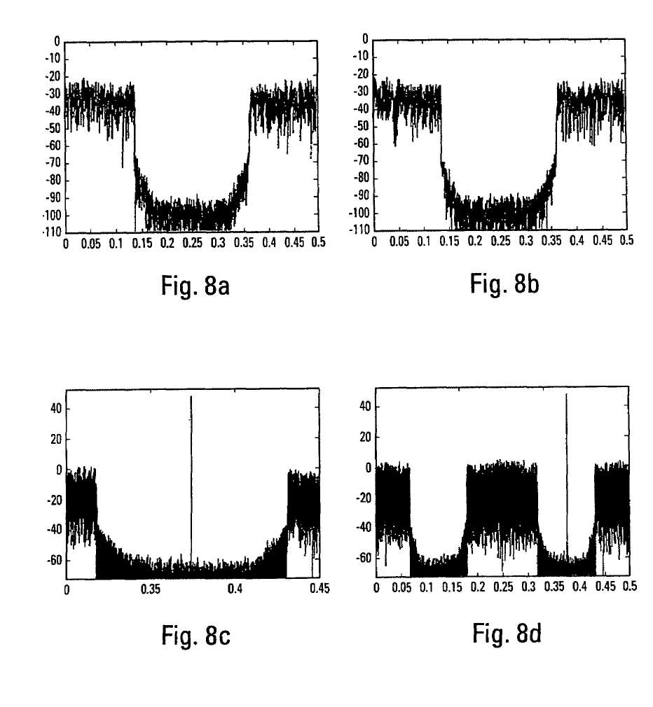

FIGS. 8a, 8b, 8c, and 8d spectral representations of the subsequences and sequences during exemplary generations of dither according to the third variant of the invention around the frequencies f_{ech}/8 and 3f_{ech}/8,
FIGS. 8a and 8b represent two basic subsequences shaped around the frequency f_{ech}/4,
FIGS. 8c and 8d represent two sequences obtained by interleaving the intermediate subsequences of FIGS. 8a and 8b, shaped, respectively, around 3f_{ech}/8, and around f_{ech}/8 and 3f_{ech}/8.

The technique described makes it possible to generate ‘dither’ with predetermined histogram shaped around an arbitrary frequency and devoid of spectral lines.

FIG. 1 shows a flowchart representing an exemplary implementation of the method for generating agitation noise according to the second variant of the invention.

The flowchart of FIG. 1 shows the steps implemented for the generation of a sequence {h(kN+n)}_{1≦n≦N}, knowing that the agitation noise comprising an arbitrary number of points, with predetermined histogram, shaped around at least one arbitrary frequency, is generated by successive generation of several sequences {h(kN+n)}_{1≦n≦N, k≦K}, with K integer ≦+∞, of M.N points (M, N integers≧1).

In the example presented, a single basic subsequence of N points {hₗ(n)}_{1≦n≦N} is selected from among L basic subsequence(s) so as to generate each sequence {h(kN+n)}_{1≦n≦N, k≦K}, during step S2.

The data at S1 generated by the flowchart of FIG. 1 therefore form a sequence of N points {h(kN+n)}_{1≦n≦N}. After choosing this subsequence I in a random and independent manner from among at least L basic subsequence(s) of N points shaped around a predetermined frequency (L integer≧1), the data obtained at S3 form this sequence {h(kN+n)}_{1≦n≦N} comprising the subsequence {hₗ(n)}_{1≦n≦N} selected. In this case the predetermined frequency is equal to the arbitrary frequency around which the agitation noise is shaped.

During step S4, the sign s applied to the chosen subsequence {hₗ(n)}_{1≦n≦N} is chosen in a random and independent manner. Thus, the data obtained at S5 form the sequence {h(kN+n)}_{1≦n≦N} comprising the selected basic subsequence {hₗ(n)}_{1≦n≦N} to which is applied the chosen sign s, {h(kN+n)}_{1≦n≦N=}{s·hₗ(n)}_{1≦n≦N}.

If the agitation noise generation method is stopped at this juncture for each sequence {h(kN+n)}_{1≦n≦N}, it corresponds to the first variant of the invention. At this juncture, the spectrum of the noise generated is devoid of spectral lines.

For the second variant of the invention, during a step S6, the direction of temporal reading of the selected basic subsequence {hₗ(n)}_{1≦n≦N} is chosen in a random and independent manner. Thus, the data S7 obtained form the sequence {h(kN+n)}_{1≦n≦N} comprising the selected basic subsequence {hₗ(n)}_{1≦n≦N} read in the chosen direction R: normal—or inverted [symbol] , and to which the chosen sign s is applied, {h(kN+n)}_{1≦n≦N}={s·hₗ(n)^{R}}_{1≦n≦N}. Therefore, the data obtained at S7ₐ when the direction of reading chosen is the normal direction are {h(kN+n)}_{1≦n≦N}={s. h̅ₗ(n)}_{1≦n≦N}={s·h1(n)}_{1≦n≦N}, and the data obtained at S7_{b} when the direction of reading chosen is the inverted direction {h(kN+n)}_{1≦n≦N}={s. h̅₁(n)}_{1≦n≦N}={s·h1(N−n)}_{1≦n≦N}.

The agitation noise thus obtained, comprising an arbitrary number of points, with predetermined histogram, shaped around a frequency consists of a succession of several sequences {h(kN+n)}_{1≦n≦N,k≦K} of M.N points (M, N integers≧1), each sequence {h(kN+n)}_{1≦n≦N} being constituted by M subsequence(s) chosen in a random and independent manner from among at least L basic subsequence(s) of N points shaped around this frequency (L integer≧1), and to each of which has been applied a sign chosen in a random and independent manner, and/or each of which having been read following a direction of temporal reading chosen in a random and independent manner.

FIG. 2 illustrates this principle of generating the agitation noise according to the second variant of the invention in the case where L=2. The abscissa axis represents the time axis, the segment k representing the kth sequence of the agitation noise generated; and the ordinate axis represents the value of the point of the sequence in terms of magnitude.

The agitation noise consists of a series of sequences of N that are chosen from among the two basic subsequences (the first being represented by crosses and the second by circles). In the time interval k−1N+n to (k+2)N+n (with 1≦n≦N), the agitation noise consists of the (k−1)th sequence corresponding to the second basic subsequence with a negative sign, the kth sequence corresponding to the first basic subsequence with a positive sign and without reversal, the (k+1)th sequence corresponding to the first basic subsequence reversed and the (k+2)th sequence corresponding to the negative second basic subsequence reversed.

In, this case, it is necessary to be furnished previously with two basic subsequences {h₁(n)}_{1≦n≦N} and {h₂(n)}_{1≦n≦N}, each shaped around the noise shaping frequency. Let h₁(n) and h₂(n) be these two basic subsequences whose number N of points (equal to a power of 2) must be greater than or equal to 2^{B} (a power of 2 times this minimum dimension) where B is the number of bits on which the points of these two basic subsequences are coded. A simple repetition of one or the other of these two basic subsequences would lead to a spectrum in the form of spectral lines.

To avoid this, the ‘dither’ or agitation noise is then constituted of a succession of K sequences of N points {h(kN+n)}_{1≦n≦N} obtained randomly and in an independent manner on the basis of one or the other of these two basic subsequences {h₁(n)}_{1≦n≦N} and {h₂(n)}_{1≦n≦N}. Moreover, from one sequence to the next, the sign s and the time reversal R (i.e. the choice of the direction of reading) of the basic subsequence used are also chosen randomly and in an independent manner. We thus obtain, from only two basic subsequences, a set of 8 series of N points that it is possible to choose randomly in an equiprobable manner.

Therefore, in a theoretical manner, the agitation noise can be given in the form:

$$h ( kN + n ) = \frac{1}{4} \{ \begin{matrix}( 1 - {σ}_{k} ) [ ( 1 - {p}_{k} ) {h}_{1} ( n ) + ( 1 + {p}_{k} ) {h}_{2} ( n ) ] + \\ ( 1 - {σ}_{k} ) [ ( 1 - {p}_{k} ) {h}_{1} ( N - n ) + ( 1 + {p}_{k} ) {h}_{2} ( N - n ) ]\end{matrix} \} {s}_{k}$$

where pₖ=±1 according to the sequence chosen, sₖ=±1 according to the sign chosen, and σₖ=±1 according to the direction of temporal reading chosen.

The points represented by crosses in the chart of FIG. 2 show these various selections (basic subsequence, sign, direction of reading) for the points of the kth component sequence {h(kN+n)}_{1≦n≦N} of the agitation noise.

The spectrum of the agitation noise thus obtained is

$${\vert H ( f ) \vert}^{2} = \frac{{\vert {H}_{1} ( f ) \vert}^{2} + {\vert {H}_{2} ( f ) \vert}^{2}}{2 T}$$

as a function of the respective spectra of the two basic subsequences used. It is a continuous spectrum devoid of spectral lines, which would not have been the case if the sequences h₁ or h₂ had been repeated in a simple manner one or the other.

As long as the choice of the sign remains random, the result remains unchanged whether or not there is reversal (i.e. inversion or not of the direction of reading) and whether we have one sequence (h₁=h₂) or several.

In the case where one would not change the sign of the sequences, two cases arise:

If we preserve the choice between two sequences the variables pₗ, pₖ and pₗpₖ are all centered and equiprobable and do not participate in the result; hence:

$$Δ {\vert H ( f ) \vert}^{2} = {Lim}_{K \to ∞} \frac{1}{KT} {\sum }_{k \neq l} [ \begin{matrix}ℛ ( \frac{{H}_{1} + {H}_{2}}{2} ) + \\ {jσ}_{l} 𝒥 ( \frac{{H}_{1} + {H}_{2}}{2} )\end{matrix} ] [ \begin{matrix}ℛ ( \frac{{H}_{1} + {H}_{2}}{2} ) - \\ {jσ}_{k} 𝒥 ( \frac{{H}_{1} + {H}_{2}}{2} )\end{matrix} ] {e}^{- j 2 π ( l - k ) f T}$$

If we do not preserve the choice between two sequences then pₖ=1 or pₖ=−1 in a continuous manner and, if hᵢ is the only sequence retained:

$$Δ {\vert H ( f ) \vert}^{2} = {Lim}_{K \to ∞} \frac{1}{KT} {\sum }_{k \neq l} [ \begin{matrix}ℛ ( {H}_{i} ) + \\ {jσ}_{l} 𝒥 ( {H}_{i} )\end{matrix} ] [ \begin{matrix}ℛ ( {H}_{i} ) - \\ {jσ}_{k} 𝒥 ( {H}_{i} )\end{matrix} ] {e}^{- j 2 π ( l - k ) f T}$$

Thus, the case where the choice of the basic subsequences is possible (L≠1), without choice of the sign, shows that there is an absence of spectral lines if the two basic sequences are mutually opposite, which case is identical to that where a single sequence is used with choice of the sign.

If we preserve reversal (i.e. the choice of the direction of reading) the variables σₗ, σₖ and σₗσₖ are all centered and equiprobable and therefore do not participate in the result; it then remains:

$$Δ {\vert H ( f ) \vert}^{2} = {Lim}_{K \to ∞} \frac{{[ ℛ ( {H}_{i} ) ]}^{2}}{KT} {\sum }_{k \neq l} {e}^{- j 2 π ( l - k ) f T}$$

If on the other hand we do not preserve reversal σₗ and σₖ equal 1 or −1 uniformly so that:

$$Δ {\vert H ( f ) \vert}^{2} = \{ \frac{- 1}{T} + \frac{1}{{T}^{2}} {\sum }_{m = - ∞}^{+ ∞} δ ( f - \frac{m}{T} ) \} {\vert {H}_{i} \vert}^{2}$$

Therefore, the case where the random choice of the direction of reading is possible, without choice of the sign, shows that the choice of the direction of reading makes it possible to have an absence of spectral lines for antisymmetric responses whose spectrum is pure imaginary.

Furthermore, the random choice of the sign makes it possible to obtain a spectral power density devoid of spectral lines.

Of course, the formation of a sequence {h(kN+n)}_{1≦n≦N} can be generalized by selecting not only a single basic subsequence but several basic subsequences. The sequence {h(kN+n)}_{1≦n≦N} will then be constituted, for example, by concatenation of basic subsequences chosen from among the L basic subsequences, or by interleaving of any arbitrary m (1≦m≦M) of the M basic subsequences selected according to a given scheme.

FIG. 3 shows a flowchart representing an exemplary implementation of the method for generating agitation noise according to the third variant of the invention.

The flowchart of FIG. 3 shows the steps implemented for the generation of a sequence {h(2kN+t)}_{1≦n≦2N}, knowing that the agitation noise comprising an arbitrary number of points, with predetermined histogram, shaped around at least one arbitrary frequency is generated by successive generation of several sequences {h(2kN+t)}_{1≦n≦2N, k≦K}, with K integer ≦+∞, of M.N points (M, N integers≧1).

In the example presented, two basic subsequences of N points {hₗ₁(n)}_{1≦n≦N}, {hₗ₂(n)}_{1≦n≦N} are selected from among L basic subsequence(s) so as to generate each sequence {h(2kN+t)}_{1≦n≦2N, k≦K}, during step S2.

The data S1 generated by the flowchart of FIG. 3 therefore form two subsequences of N points {hₑ₁(n)}_{1≦n≦N}, {hₑ₂(n)}_{1≦n≦N}. After choosing these subsequences I₁ and I₂ in a random and independent manner from among at least L basic subsequence(s) of N points shaped around a predetermined frequency (L integer≧1), the data obtained S3 form the subsequences {hₑ₁(n)}_{1≦n≦N}, {hₑ₂(n)}_{1≦n≦N} comprising, respectively the subsequences {hₗ₁(n)}_{1≦n≦N}, {hₗ₂(n)}_{1≦n≦N} selected. In this case, the predetermined frequency is equal to double the arbitrary frequency around which the agitation noise is shaped.

During step S4, the signs s₁ and s₂ applied respectively to the chosen subsequences {hₗ₁(n)}_{1≦n≦N}, {hₗ₂(n)}_{1≦n≦N} are chosen in a random and independent manner. Thus, the data S5 obtained form the subsequences {hₑ₁(n)}_{1≦n≦N}, {hₑ₂(n)}_{1≦n≦N} comprising, respectively the subsequences {hₗ₁(n)}_{1≦n≦N}, {hₗ₂(n)}_{1≦n≦N} selected to which are applied, respectively, the chosen signs s₁ and s₂, {hₑ₁(n)}_{1≦n≦N}={s₁·hₗ₁(n)}_{1≦n≦N} and {hₑ₂(n)}_{1≦n≦N}={s₂·hₗ₂(n)}_{1≦n≦N}.

During a step S6, the directions of temporal reading of the subsequences {hₗ₁(n)}_{1≦n≦N}, {hₗ₂(n)}_{1≦n≦N} selected are chosen in a random and independent manner. Thus, the data S7 obtained form the subsequences {hₑ₁(n)}_{1≦n≦N}, {hₑ₂(n)}_{1≦n≦N} comprising, respectively the subsequences {hₗ₁(n)}_{1≦n≦N}, {hₗ₂(n)}_{1≦n≦N} selected read, respectively, in the chosen directions R₁ and R₂, and to which are applied, respectively, the chosen signs s₁ and s₂, {hₑ₁(n)}_{1≦n≦N}={s₁·hₗ₁(n)^{R1}}_{1≦n≦N} and {hₑ₂(n)}_{1≦n≦N}={s₂·hₗ₂(n)^{R2}}_{1≦n≦N}.

This step of the choice of the direction of reading S7 is optional as shown in FIG. 3 by following the dashed arrows after step S5 until step S8 of interleaving.

Therefore, in step S8 of interleaving E, two subsequences {hₑ₁(n)}_{1≦n≦N}, {hₑ₂(n)}_{1≦n≦N} are received corresponding to the data S5 arising from step S4 of choosing signs or to the data S7, arising from step S6 of choosing the direction of reading.

These two subsequences {hₑ₁(n)}_{1≦n≦N}, {hₑ₂(n)}_{1≦n≦N} are interleaved according to a given scheme, for example by alternating a point of the first subsequence {hₑ₁(n)}_{1≦n≦N}, and a point of the second subsequence {hₑ₂(n)}_{1≦n≦N} as in the example illustrated by FIG. 3.

The data S8 obtained thus form the agitation noise sequence as a function of these two subsequences in the following manner:

{h(2kN+2n)}_{1≦n≦N=}{hₑ₁(n)}_{1≦n≦N}={s₁·hₗ₁(n)^{R1}}_{1≦n≦N},

and

{h(2kN+2n−1)}_{1≦n≦N=}{hₑ₂(n)}_{1≦n≦N}={s₂·hₗ₂(n)^{R2}}_{1≦n≦N}

In generalizing this interleaving scheme to m basic subsequences (1≦m≦M), the agitation noise is given by the following equations:

{h(mkN+mn)}_{1≦n≦N=}{hₑ₁(n)}_{1≦n≦N}={s₁·hₗ₁(n)^{R2}}_{1≦n≦N};

{h(mkN+mn−1))}_{1≦n≦N=}{hₑ₂(n)}_{1≦n≦N}={s₂·hₗ₂(n)^{R2}}_{1≦n≦N};

. . .

{h(mkN+mn−(m−1))}_{1≦n≦N=}{hₑ₂(n)}_{1≦n≦N}={s₂·hₗ₂(n)^{R2}}_{1≦n≦N}.

FIG. 4 illustrates this principle for generating the agitation noise according to the third variant of the invention in the case where L=2.

The procedure described by FIG. 3 is of course applicable to the three particular frequencies ±f_{ech}/4, ±f_{ech}/8 and +3f_{ech}/8 (modulo f_{ech}), where f_{ech} is the sampling frequency. However, for these precise frequencies, it is possible, with the same idea in mind, to proceed slightly differently as illustrated in FIG. 3. For this purpose it is necessary to be furnished previously with two basic subsequences {h1(n)}_{1≦n≦N} and {h2(n)}_{1≦n≦N}, each shaped around f_{ech}/2 for a final shaping of the agitation noise at f_{ech}/4 or around f_{ech}/4 for a simultaneous final shaping of the agitation noise at +f_{ech}/8 and ±3f_{ech}/8.

In this case the ‘dither’ is then constituted by a succession of series of 2N points defined by interleaving of two subsequences {hₗ₁(n)}_{1≦n≦N}, {hₗ₂(n)}_{1≦n≦N} of N points chosen randomly and in an independent manner from among these two basic subsequences {h1(n)}_{1≦n≦N} and {h2(n)}_{1≦n≦N}, as well as for each of them, the sign s₁ or s₂ and the time reversal R₁ or R₂. Thus, from only two basic subsequences {h1(n)}_{1≦n≦N} and {h2(n)}_{1≦n≦N}, a set of 64 series of 2N points is obtained from which a sequence {h(2kN+t)}_{1≦n≦2N} of 2N points can be chosen in a randomly and equiprobable manner. Through the effect of the interleaving, the spectrum of each of these 64 series is shaped around f_{ech}/4 (modulo f_{ech}) or simultaneously around f_{ech}/8 and ±3f_{ech}/8 (modulo f_{ech}) depending on whether we started from basic subsequences {h1(n)}_{1≦n≦N} and {h2(n)}_{1≦n≦N} having a spectrum shaped around f_{ech}/2 or f_{ech}/4.

The interleaving of X subsequences makes it possible to transpose the spectra (using a scale factor equal to X) around the frequency ±(f₀/X+kf_{ech}/X) where f₀ is the central frequency of the basic subsequences (for X=2, the spectrum is transposed to half the frequency). If this ‘transposition’ is not sought, the same approach applies by reading subsequences successively, without interleaving them.

In a theoretical manner, the agitation noise can be given in the form:

$$\begin{matrix} h ( kN + 2 n - 1 ) = \frac{1}{4} \{ \begin{matrix}( 1 + {σ}_{k}^{′} ) [ \begin{matrix}( 1 - {p}_{k}^{′} ) {h}_{1} ( n ) + \\ ( 1 + {p}_{k}^{′} ) {h}_{2} ( n )\end{matrix} ] + \\ ( 1 - {σ}_{k}^{′} ) [ \begin{matrix}( 1 - {p}_{k}^{′} ) {h}_{1} ( N - n ) + \\ ( 1 + {p}_{k}^{′} ) {h}_{2} ( N - n )\end{matrix} ]\end{matrix} \} {s}_{k}^{′} \\ h ( kN + 2 n ) = \frac{1}{4} \{ \begin{matrix}( 1 + {σ}_{k}^{″} ) [ \begin{matrix}( 1 - {p}_{k}^{″} ) {h}_{1} ( n ) + \\ ( 1 + {p}_{k}^{″} ) {h}_{2} ( n )\end{matrix} ] + \\ ( 1 - {σ}_{k}^{″} ) [ \begin{matrix}( 1 - {p}_{k}^{″} ) {h}_{1} ( N - n ) + \\ ( 1 + {p}_{k}^{″} ) {h}_{2} ( N - n )\end{matrix} ]\end{matrix} \} {s}_{k}^{″}\end{matrix}$$

where p′ₖ=±1, p″ₖ=±1 according to the sequence chosen, s′ₖ=±1, s″ₖ=±1 according to the sign chosen, and σ′ₖ=±1, σ″ₖ=−1 according to the direction of temporal reading chosen.

The spectrum of the agitation noise thus obtained is

$${\vert H ( f ) \vert}^{2} = \frac{{\vert {H}_{1} ( f / 2 ) \vert}^{2} + {\vert {H}_{2} ( f / 2 ) \vert}^{2}}{T} .$$

It is a continuous spectrum devoid of spectral lines, and of shaping frequency equal to half the frequency of the basic subsequences.

The points represented by crosses in the chart of FIG. 4 show these various selections (basic subsequence, sign, direction of reading) for the even points of the kth component sequence {h(2kN+2n)}_{1≦n≦N} of the agitation noise and circles for the odd points {h(2kN+2n−1)}_{1≦n≦N}, in the particular case of the exemplary interleaving scheme illustrated by FIG. 3.

The basic subsequences used are subsequences of N points shaped around a predetermined frequency, and at least with predetermined shape histogram. These basic subsequences are of reduced sizes (N points). Basic subsequences such as these able to be used to generate dither with a predetermined histogram can be obtained according to the method of patent FR No. 02 15066, making it possible to approximate noise with flat histogram. The basic subsequences used can also have rigorously flat histogram.

FIG. 5b represents a basic subsequence thus obtained from a white noise represented in FIG. 5a.

FIG. 6 proposes an exemplary embodiment of the agitation noise generation device according to the third variant of the invention.

This device for generating agitation noise comprises means 1 for selecting M subsequence(s) in a random and independent manner from among at least L basic subsequence(s) of N points shaped around a predetermined frequency (L integer≧1). Means of storage 3 of basic subsequence comprise these L basic subsequence(s). The subsequence selection means 1 communicates to reading means 2 the or some basic subsequence(s) chosen so that these reading means will search for them in the storage means 3.

Sign selection means 4 choose for each of the subsequences selected in a random and independent manner a sign that they apply to them.

In the case of the first variant of the invention, the subsequences thus obtained (choice of subsequence, sign) are, possibly, concatenated into sequences {h(kN+n)}_{1≦n≦N} of M.N points, if M≠1, and provided to the provision means 7 which successively provide several sequences of M.N points (M, N integers≧1) constituting the agitation noise.

Means for selecting the direction of temporal reading of each of the chosen basic subsequences 5 choose to temporally reverse or otherwise the subsequences selected in a random and independent manner.

In the case of the second variant of the invention, the subsequences thus obtained (choice of subsequence, sign and direction of reading) are, possibly, concatenated into sequences {h(kN+n)}_{1≦n≦N} of M.N points, if M≠1, and provided to the provision means 7 which successively provide several sequences {h(kN+n)}_{1≦n≦N} of M.N points (M, N integers≧1) constituting the agitation noise.

Interleaving means 6 receive, in the case of the third variant of the invention, several selected subsequences and interleave them according to one or more predetermined scheme(s) all together or in blocks of a determined number of subsequences. Possibly, certain subsequences are not interleaved and are concatenated with the subsequences obtained by interleaving. The final sequence obtained {h(kN+n)}_{1≦n≦N} is provided to the provision means 7 which successively provide several sequences to constitute the agitation noise h.

The number of iteration by the interleaving means thus depends on the shaping frequency of the basic subsequence and the shaping frequency desired for the agitation noise.

Thus, when a single basic subsequence is used, the histogram of the sequence obtained is identical to that of the basic subsequence used. And, when several basic subsequences are used, the histogram of the sequence obtained is the average of the histograms of the basic subsequences used. The noise generation procedure thus implemented complies, therefore, with the histogram thus making it possible to obtain noise with a histogram predetermined as a function of the histogram(s) of the basic subsequence(s).

FIGS. 7a, 7b, 7c, 7d, 7e and 7f propose an example where the basic subsequences are shaped around half of the sampling frequency f_{ech}/2 and the shaping frequency desired for the agitation noise is f_{ech}/4.

FIGS. 7a and 7b represent the spectrum of two distinct basic subsequences shaped around the frequency f_{ech}/2.

By interleaving the basic subsequence of FIG. 7a with itself, the spectrum obtained is that represented by FIG. 7c. In this case, for a number of points 2²⁰, the signal-to-noise ratio is 77 dB in the frequency band f_{ech}/4±5% with a linearity of 107 dBc.

By interleaving the basic subsequence of FIG. 7b with itself, the spectrum obtained is that represented by FIG. 7d. In this case, for a number of points 2²⁰, the signal-to-noise ratio is 78 dB in the frequency band f_{ech}/4±5% with a linearity of 109 dBc.

By interleaving the basic subsequences of FIGS. 7a and 7b, the spectrum obtained is that represented by FIGS. 7e and 7f. In this case, for a number of points 2²⁰, the signal-to-noise ratio is 78 dB in the frequency band f_{ech}/4±5% with a linearity of 109 dBc, and a maximum noise density of 120 dBc per point.

FIGS. 8a, 8b, 8c, and 8d propose an example where the basic subsequences are shaped around a quarter of the sampling frequency f_{ech}/4 and the central shaping frequencies desired for the agitation noise are f_{ech}/8.

By interleaving the subsequences obtained of FIGS. 8a and 8b, the spectrum obtained is that represented by FIGS. 8c and 8d. This spectrum is shaped around the frequencies f_{ech}/8 and 3f_{ech}/8. In this case, for a number of points 2²⁰, the signal-to-noise ratio is 67 dB in the frequency band f_{ech}/8±5% with a linearity of 93 dBc.

The agitation noise generation method is thus relatively simple to implement and allows fast calculation of this agitation noise from equiprobable stored basic subsequence(s) of reduced size shaped around a given frequency.

This agitation noise generation method can be used to linearize their characteristics of devices such as digital analog or analog digital converters, for example.

Another use of this agitation noise generation method can also be frequency synthesis (DDS, i.e. Direct Digital Synthesis).

The use of the noise generation method with predetermined histogram, in particular with rigorously flat histogram, shaped around an arbitrary frequency according to the invention upstream of the analog digital converter of the direct channel of a sigma delta modulator makes it possible to linearize the digital analog converter of the return channel of the sigma delta modulator. An adder will add the agitation noise generated by the agitation noise generation device to the input of the analog digital converter. Furthermore, another effect of the use of the noise generation method with predetermined histogram, in particular with rigorously flat histogram, shaped around an arbitrary frequency according to the invention can be the stabilization of the sigma delta modulator (by avoiding the effect of divergence).

1. A method for generating agitation noise comprising an arbitrary number of points, with predetermined histogram, shaped around at least one arbitrary frequency, comprising:
generation of noise by a succession of several sequences {h(kN+n)}_{1≦n≦N} of M.N points (M, N integers≧1), choosing for each sequence of M basic subsequence(s) {hₗₘ(n)}_{1≦n≦N, m≦M} in a random and independent manner from among at least L basic subsequence(s) of N points shaped around a predetermined frequency (L integer≧1),
choosing in a random and independent manner, for each sequence, of the sign s applied to each of the chosen subsequences.

2. The method for generating agitation noise according to claim 1 wherein choosing in a random and independent manner, for each sequence, of the direction of temporal reading R of each of the chosen basic subsequences.

3. The method for generating agitation noise according to claim 1 wherein M=1.

4. The method for generating agitation noise according to claim 1 wherein the predetermined shaping frequency of the basic subsequences is equal to the arbitrary shaping frequency of the noise.

5. The method for generating agitation noise according to claim 1 wherein for each sequence, the interleaving E of several subsequences.

6. The method for generating agitation noise according to claim 1 wherein the interleaved subsequences are either the M subsequences {hₗₘ(n)}_{1≦n≦N, m≦M} chosen from among L basic subsequences, or the ones part of the M chosen subsequences {hₗₘ(n)}_{1≦n≦N, m≦M} from among L basic subsequences, or several subsequences obtained by interleaving of several basic subsequences {hₗ(n)}_{1≦n≦N}.

7. The method for generating agitation noise according to claim 5 wherein M=L.

8. The method for generating agitation noise according to claim 5 wherein the predetermined shaping frequency of the basic subsequences is equal to double at least one of the arbitrary shaping frequencies of the noise.

9. The method for generating agitation noise according to claim 1 wherein the choosing of a basic subsequence {hₗ(n)}_{1≦n≦N} leads to the reading of this basic subsequence in storage means.

10. The method for generating agitation noise according to claim 1 wherein the basic subsequences {hₗ(n)}_{1≦n≦N} are equiprobable signals shaped around a predetermined frequency.

11. The device for generating an agitation noise comprising an arbitrary number of points, with predetermined histogram, shaped around at least one arbitrary frequency implementing the method of claim 1 comprising:
means of successive provision of several sequences {h(kN+n)}_{1≦n≦N} of M.N points (M, N integers≧1),
means of selection, for each sequence, of M subsequence(s) {hₗₘ(n)}_{1≦n≦N, m≦M} in a random and independent manner from among at least L basic subsequence(s) of N points shaped around a predetermined frequency (L integer≧1),
means of selection, in a random and independent manner, for each sequence, of the sign applied to each of the chosen subsequences {hₗₘ(n)}_{1≦n≦N, m≦M}.

12. The device for generating agitation noise according to claim 11 wherein it comprises means of selection, in a random and independent manner, for each sequence, of the direction of temporal reading of each of the chosen basic subsequences.

13. The device for generating agitation noise according to claim 11 wherein it comprises means of interleaving of the M chosen subsequences, for each sequence.

14. The device for generating agitation noise according to claim 11 wherein it comprises means of storage of a basic subsequence and means of reading of the chosen basic subsequence {hₗₘ(n)}_{1≦n≦N, m≦M} in the storage means.

15. The digital analog converter comprising an agitation noise generation device as claimed in claim 11.

16. The frequency synthesis system comprising an agitation noise generation device as claimed in claim 11.

17. The sigma delta modulator comprising an analog digital converter on the direct channel, an agitation noise generation device as claimed in claim 11, an adder adding the agitation noise generated by the agitation noise generation device to the input of the analog digital converter, and a digital analog converter on the return channel.
